(19) United States
(12) Patent Application Publication
(10) Pub. No.: US 2002/0160800 A1
(43) Pub. Date: Oct. 31, 2002

(54) Method and system for providing a multi-level power control loop

(76) Inventor: Jack Rozmaryn, Silver Spring, MD (US)

Correspondence Address: Hughes Electronics Corporation, Patent Docket Administration, Bldg. 1, Mail Stop A109, P.O Box 956, El Segundo, CA, 90245-0956, US

(21) Appl. No.: 09/963,222

(22) Filed: Sep. 26, 2001

Related U.S. Application Data
(60) Provisional application No. 60/286,280, filed on Apr. 25, 2001.

(51) Int. Cl. H04B 7/00

(52) U.S. Cl. 455/522; 455/68; 455/69

(57) ABSTRACT

An approach for providing power control of a radio terminal is disclosed. A first control loop is performed according to a first set of signal parameters (e.g., signal-to-noise level) to adjust power level of the radio terminal based upon a received signal from the radio terminal. Further, a second control loop is performed according to a second set of signal parameters (e.g., raw bit error rate (BER)) to refine the power adjustment of the first control loop. The present invention has particular applicability to a point-to-multi-point or a point-to-point radio system.

### RELATED APPLICATIONS

The present application is related to and claims the benefit of the earlier filing date of U.S. Provisional Patent Application (Attorney Docket Number: PD-201098), filed on Apr. 25, 2001 and entitled “Loop BER Power Control for Point to Multipoint Millimeter Wave Transmission”; the contents of which are hereby incorporated by reference.

### FIELD OF THE INVENTION

The present invention relates to a radio communications system, and more particularly to providing power control of a radio terminal.

### BACKGROUND OF THE INVENTION

Wireless communications systems provide a convenient approach to deploying a voice and data infrastructure. With the advances in signal processing and communications technologies, the bandwidth and performance of such wireless systems rival that of terrestrial networks. Because wireless systems can be rapidly and cost-effectively deployed, such systems have enabled service providers to enter the broadband access market with minimal capital investment. However, as the number of radio terminals increases, transmission interference (cochannel and adjacent channel interference) poses a severe constraint on deployment in terms of density.

Conventional wireless systems, such as point-to-multipoint (PMP) and point-to-point networks, have a number of drawbacks that impede their competitiveness with equivalent terrestrial solutions. Specifically, PMP networks suffer from the “near-far problem.” This near-far problem arises because of a variation in how close one remote terminal is to a hub terminal relative to another remote terminal; in particular, in the uplink broadcast direction or the remote to the multipoint hub direction. For example, a remote terminal is located close to the hub terminal while another remote terminal at an adjacent frequency channel maybe located at the edge of coverage. Consequently, the adjacent channel energy for a high-powered terminal may overpower the terminal at the edge of coverage, thereby disrupting service of the terminal at the edge. Also, because each remote radio generates radio frequency (RF) energy, it produces interference with other radios using the same frequencies. Therefore, minimizing the output power of the remote radio minimizes the cochannel interference.

Conventional approaches have utilized a feedback loop that is solely based upon a measured received signal level (RSL) or Received Signal Strength Indicator (RSSI) to control the transmission power of the radio terminals. Such approaches have a number of drawbacks. One drawback is that absolute RSL measurements tend to be inaccurate and lead to network imbalances, thereby causing higher cochannel interference to be generated—if the RSL error is negative. Also, if the RSL error is positive, the terminal may experience a higher bit error rate (BER). Another drawback stems from that fact that the RSL measurement is not sensitive to any cochannel interference that may exist, as RSL only indicates the received power.

Therefore, there is a need for an approach for providing accurate power control of a radio terminal. There is also a need to utilize system resources efficiently.

### SUMMARY OF THE INVENTION

These and other needs are addressed by the present invention, which provides a multi-level power control loop to control power of a radio terminal. In an exemplary embodiment, three levels of power control loops form the multi-level power control loop. The third level loop modifies the adjustments of the second level loop, which in turn, corrects the power adjustments made by the first level loop. The first level control loop uses a Receive Signal Level (RSL) or Received Signal Strength Indicator (RSSI) parameter to power control the radio terminal to a specified signal level. The second level loop controls the power level based on a Signal-to-Noise ratio level (C/I), while the third level loop utilizes a pre-FEC (forward error correction) Bit Error Rate (BER) to control the output power. The present invention advantageously minimizes interference and enhances efficient use of system resources by enabling the use of accurate signal parameters (e.g., BER).

According to one aspect of the present invention, a method for providing power control of a radio terminal is disclosed. The method includes receiving a signal from the radio terminal. The method also includes performing a first control loop according to a first set of signal parameters to adjust power level of the radio terminal based upon the received signal. Further, the method includes performing a second control loop according to a second set of signal parameters to refine the power adjustment of the first control loop.

According to another aspect of the present invention, a terminal apparatus for providing power control of a radio terminal is disclosed. The apparatus includes an antenna that is configured to receive a signal from the radio terminal. Additionally, the apparatus includes logic that is configured to perform a first control loop according to a first set of signal parameters to adjust power level of the radio terminal based upon the received signal. The logic is further configured to perform a second control loop according to a second set of signal parameters to refine the power adjustment of the first control loop.

According to another aspect of the present invention, a terminal apparatus for providing power control of a radio terminal is disclosed. The apparatus includes a communications interface that is configured to receive data from a host. The apparatus also includes a transmitter that is configured to transmit a signal representing the data from the host to a hub terminal. Further, the apparatus includes an attenuator that is coupled to the transmitter and configured to control power level of the signal. The hub terminal includes logic that is configured to perform a first control loop according to a first set of signal parameters to control the attenuator to adjust power level of the transmitter based upon the received signal. The logic is further configured to perform a second control loop according to a second set of signal parameters to refine the power adjustment of the first control loop.

According to another aspect of the present invention, a communications system for providing multi-level transmission power control is disclosed. The system includes a first terminal that is configured to receive data from a host and to transmit a signal representing the data from the host. The system also includes a second terminal that is configured to receive the signal. The second terminal includes logic that is configured to perform a first control loop according to a first set of signal parameters to adjust power level of the first terminal based upon the received signal. The logic is further configured to perform a second control loop according to a second set of signal parameters to refine the power adjustment of the first control loop.

In yet another aspect of the present invention, a terminal apparatus for providing power control of a radio terminal is disclosed. The apparatus includes means for receiving a signal from the radio terminal, and means for performing a first control loop according to a first set of signal parameters to adjust power level of the radio terminal based upon the received signal. Also, the apparatus includes means for performing a second control loop according to a second set of signal parameters to refine the power adjustment of the first control loop.

In yet another aspect of the present invention, a computer-readable medium carrying one or more sequences of one or more instructions for providing power control of a radio terminal is disclosed. The one or more sequences of one or more instructions includes instructions which, when executed by one or more processors, cause the one or more processors to perform the step of performing a first control loop according to a first set of signal parameters to adjust power level of the radio terminal based upon a received signal from the radio terminal. Another step includes performing a second control loop according to a second set of signal parameters to refine the power adjustment of the first control loop.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communications system that utilizes a point-to-multi-point (PMP) radio network, according to an embodiment of the present invention;

FIG. 2 is a diagram of a dual channel terminal used in the PMP radio network of FIG. 1;

FIG. 3 is a diagram of an indoor unit (IDU) of the dual channel terminal of FIG. 2;

FIG. 4 is a diagram of a remote terminal configured as a repeater, according to an embodiment of the present invention;

FIG. 5 is a diagram of a remote terminal used in conjunction with a hub terminal, according to an embodiment of the present invention;

FIG. 6 is a diagram of a remote terminal having a sectorized antenna and communicating with a hub terminal over a point-to-point channel, according to an embodiment of the present invention;

FIG. 7 is a diagram of a hub terminal capable of employing a multi-level power control loop, according to an embodiment of the present invention;

FIG. 8 is a diagram of logic for providing a multi-level power control loop, according to an embodiment of the present invention;

FIG. 9 is a flowchart of a process for providing a multi-level power control loop, according to an embodiment of the present invention; and

FIG. 10 is a diagram of a computer system that can be used to implement an embodiment of the present invention.

### DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is described with respect to a point-to-multi-point (PMP) system, it is recognized that the present invention has applicability to radio communication systems in general, such as a point-to-point system.

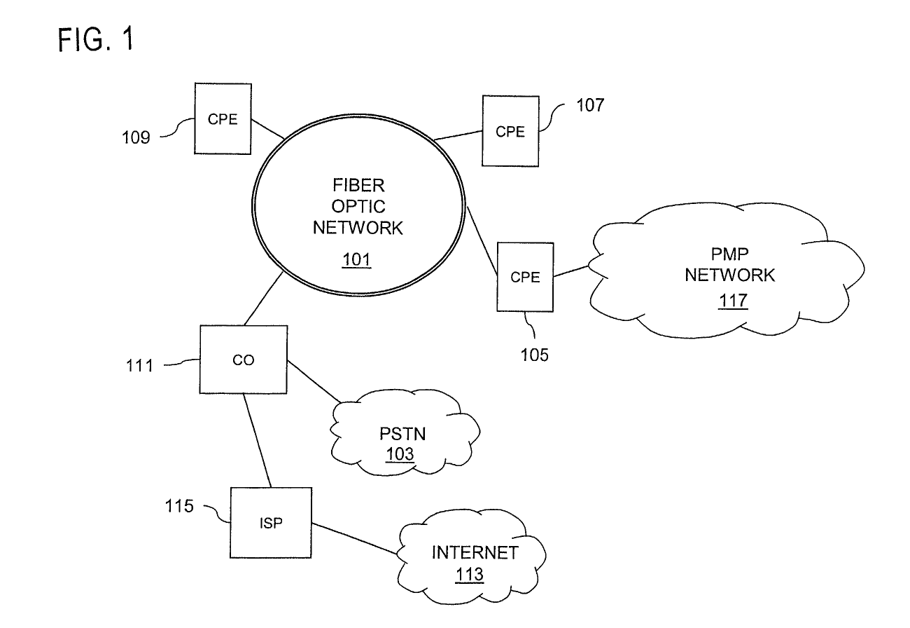

FIG. 1 shows a diagram of a communications system that utilizes a point-to-multipoint (PMP) radio network, according to an embodiment of the present invention. A communications system 100, in an exemplary embodiment, may be deployed in a metropolitan environment in which a fiber optic network 101 carries traffic from the public switched telephone network (PSTN) 103 to a number of customer premise equipment (CPE) 105, 107, 109. A central office (CO) 111 originates traffic from the PSTN 103 as well as the Internet 113, to which the CO 111 is connected via an Internet Service Provider (ISP) 115.

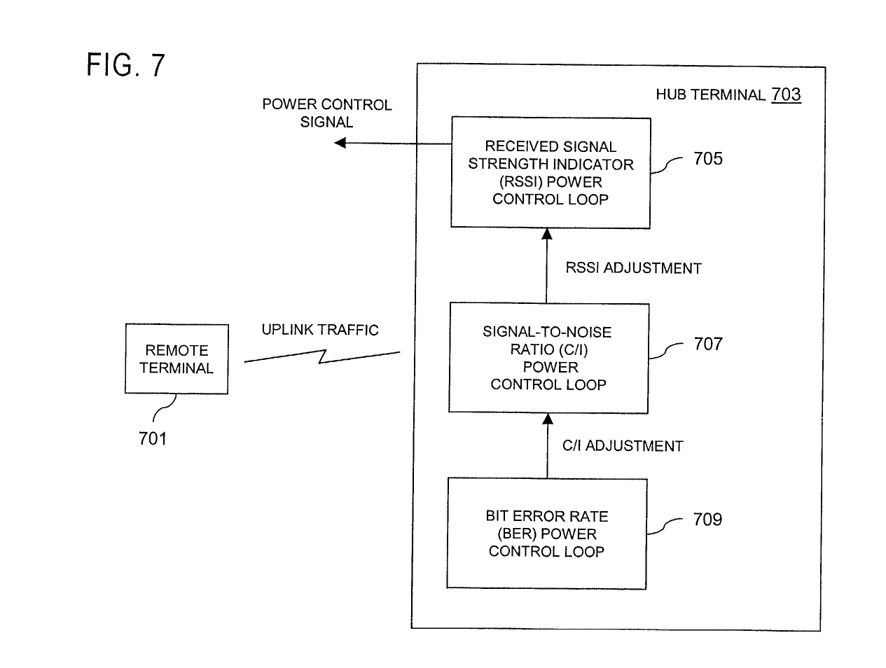

In this example, the CPE 105 has connectivity to a PMP network 117. The PMP network 115, which operates in the microwave frequency range, is a wireless network that transports traffic to and from the fiber optic network 101. Within the PMP network 117 are a number of terminals that are configured as remote terminals and hub terminals. As will be more fully described later with respect to FIGS. 7-9, the hub terminals are capable of performing a multi-level power control loop to minimize transmission interference.

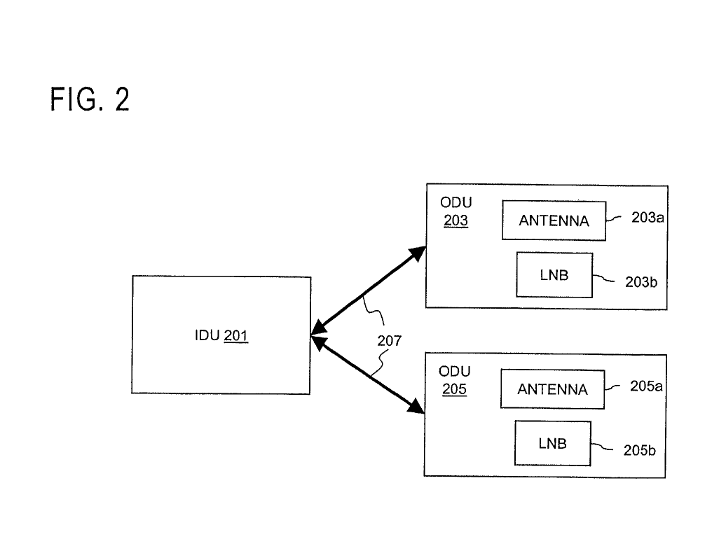

FIG. 2 shows a diagram of a dual channel terminal used in the PMP radio network of FIG. 1. In an exemplary embodiment, a terminal 200 includes an indoor unit (IDU) 201 and multiple outdoor units (ODUs) 203, 205. Each of the ODUs 203, 205 include an antenna 203a, 205aand a Low Noise Block (LNB) 203b, 205b. As will be described later, the antennas 203a, 205a may be sectorized.

Multiple ODUs 203, 205 simultaneously support multiple (in this example, two) channels and couple to the IDU 201 over IFL (inter-facilities link) cables 207, which may be optical. It is recognized that although two ODUs 203, 205 are described, in general any number of ODUs may be utilized. The use of multiple ODUs 203, 205 advantageously provides high availability to the subscriber, in that if one of the ODUs 203, 205 fails, the other ODU switches in. Since the terminal 200 is a true dual channel terminal 200, the backup ODU can be concurrently operational in a load-sharing mode, or in a test-mode.

Under this arrangement, the transmitter and receiver and all components of the ODU 203, 205 may be continually tested. Thus, if a failure occurs, it can be assured that the backup ODU will be operational. If the backup ODU is not tested, then over the life of the product, there is about a 50% probability that the backup ODU will fail. The continual testing of the backup ODU eliminates a hidden failure. In other words, if the backup ODU fails before the primary ODU, a hidden failure results, in that when the primary fails at a later time, the switchover will fail. The use of multiple ODUs 203, 205, which are essentially operational full-time, avoids a hidden failure of the backup ODU.

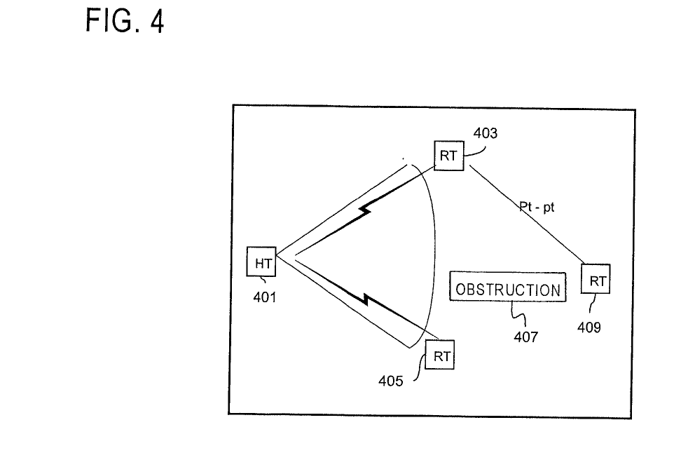

As another feature, the terminal 200 may operate as a repeater, and thereby, serve to extend the coverage area of the network. The repeater function of the terminal 200 forwards the traffic from another terminal (e.g., a hub terminal) to a destination terminal. The frequency that is used to forward the traffic can be the same or different frequency. In addition, the repeater terminal 200 can statistically multiplex the traffic from the new terminal 200. This repeater function is further described below in FIGS. 4-6.

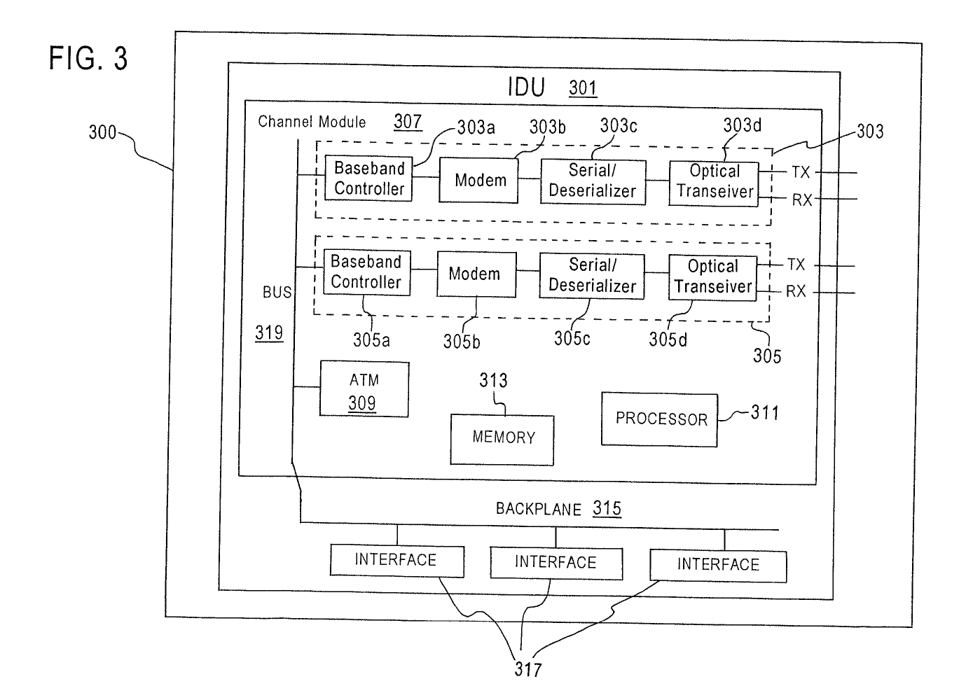

FIG. 3 shows a diagram of an indoor unit (IDU) of the dual channel terminal of FIG. 2. The Dual Channel RT block diagram is shown in FIG. 3. An IDU 301, in an exemplary embodiment, has two transceiver chains 303, 305, which are located on a channel module 307. Each of the transceiver chains 303, 305 includes a baseband controller 303a, 305a, a digital modem 303b, 305b, a serial/deserializer 303c, 305c, and an optical transceiver (i.e., transmitter/receiver) 303d, 303d. The channel module also includes common elements, such as a switching engine 309 (e.g., an Asynchronous Transfer Mode (ATM) switch), a network and control processor 311, memory 313, and a timing recovery circuit (not shown). In addition to the channel module 307, the terminal 300 has a backplane 315 and interfaces 317; in an exemplary embodiment, three interface cards are provided.

The baseband controllers 303a, 305a interface the ATM Engine 309 via a bus 319, which is extended across the backplane 315 to the three interface cards 317. This arrangement permits traffic from the ODUs and the interface cards 317 to be statistically multiplexed, such that the traffic can be switched in any direction among all of these elements.

The ODU interface block (not shown), in an exemplary embodiment, uses a fiber optic link between the ODU and IDU, as discussed in FIG. 2. According to an embodiment of the present invention, a fiber optic interface is used because such an interface occupies a relatively small board area as compared to a non-fiber optic interface; as a result, the electronics to support multiple channels simultaneously can be packed into the space of a single channel that does not use the fiber optic interface. However, it is recognized that a non-fiber optic interface may be used, with a corresponding increase in the packaging.

One advantage of the dual channel architecture of the terminal 300 is that a mode with 1:1 redundant ODUs provides increased system availability, thereby improving service to the subscriber. Given the competitive wireless market, a key differentiator for service providers (e.g., Competitive Local Exchange Carriers) is availability. Furthermore, the dual channel terminal 300 can be deployed to extend the coverage area, as discussed below in FIG. 4.

FIG. 4 shows a diagram of a remote terminal configured as a repeater, according to an embodiment of the present invention. As noted earlier, the limitation on the range of a wireless system has hindered the deployment of such systems. The terminal of the present invention can be utilized in various wireless communications systems, such as a point-to-multipoint (PMP) system or point-to-point system to provide increased subscriber coverage by operating in the repeater mode, as previously discussed. The dual channel terminal, in an exemplary embodiment, may take the form of a remote terminal (RT) or a hub terminal (HT). In general, an RT resides at the customer location and communicates with the HT, which may serve one or more RTs over a wireless link. The wireless link is shared among the multiple remote terminals.

FIG. 4 shows an HT 401 that can transmit to RTs 403 and 405. An obstruction 407 exists between the HT 401 and an RT 409. This scenario reflects the landscape of many metropolitan areas, in which approximately 20-60% of the desired RT buildings is obstructed from the line-of-site to the hub location. By using an RT in a repeater mode, obstructed sites can be served. In this example, the RT 409 can still be served by the HT 401 via the RT 403, which operates as a repeater for the transmissions from the HT 401 to the RT 409. The arrangement of FIG. 4, therefore, can effectively extend the service coverage of the HT 401 to RT 409, despite the obstruction 407. The use of a dual channel terminal, as provided by the present invention, enables great flexibility in the topology.

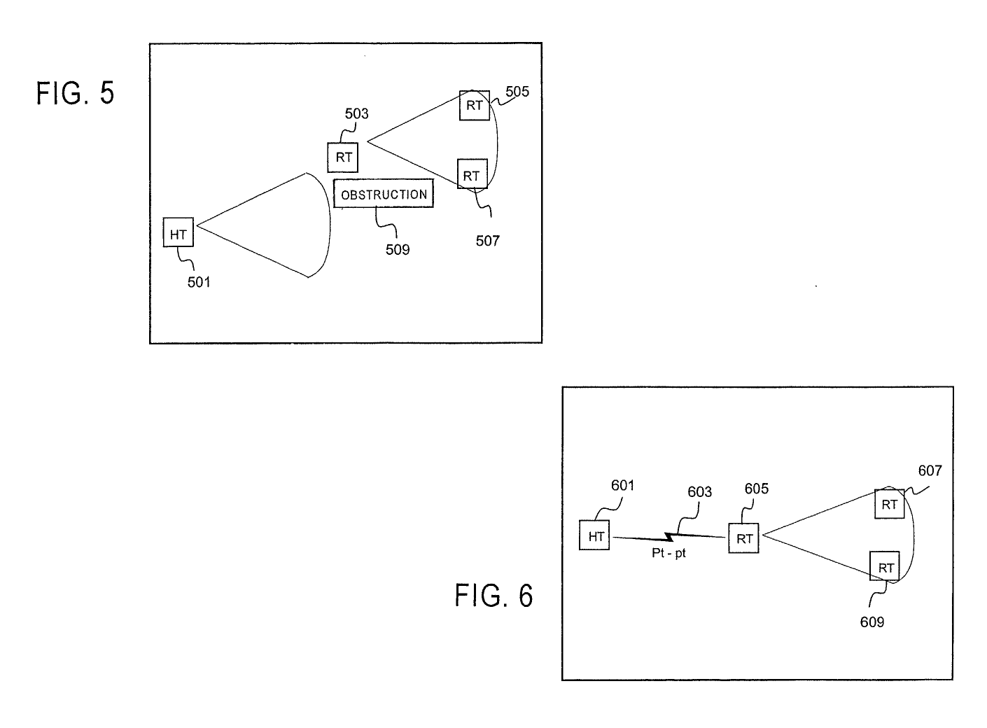

FIG. 5 shows a diagram of a remote terminal used in conjunction with a hub terminal, according to an embodiment of the present invention. Another possible use of the dual channel RT is to use the repeater function with a sectorized antenna (e.g., 90°, 45°, or 22.5°). As shown, an HT 501 broadcasts to an RT 503. The RT 503, in turn, can perform as a repeater for the transmissions from the HT 501 to RTs 505 and 507. Effectively, the repeater function of the RT 503 enables the RT 503 to behave as an HT. Consequently, the obstruction 509, which in a conventional wireless system would not allow the RTs 505, 507 to be a part of the subscriber coverage area, is circumvented.

It is noted that any number of antenna combinations, including a narrow beam antenna (e.g., 1.6°) and sectorized antennas, can be used on both ODUs.

FIG. 6 shows a diagram of a remote terminal having a sectorized antenna and communicating with a hub terminal over a point-to-point channel, according to an embodiment of the present invention. In this scenario, a HT 601 communicates over a point-to-point wireless link 603 to an RT 605. The RT 605, in repeater mode, can in turn communicate with RTs 607, 609.

FIG. 7 shows a diagram of a hub terminal capable of employing a multi-level power control loop, according to an embodiment of the present invention. To effectively address the near-far problem as discussed earlier, uplink power control is necessary. In this manner, cochannel and adjacent channel interference, which are caused by remote terminals operating at too high a power level, can be minimized. As seen in FIG. 7, a remote terminal (RT) 701 transmits uplink traffic to a hub terminal (HT) 703 according to some transmission power level. Depending on the relative distance that the RT 701 is from the HT 703, the transmission power level may cause interference, as discussed above.

Conventional approaches focus on providing uplink power control based solely on received signal level (RSL). As previously noted, absolute RSL or RSSI measurements tend to be inaccurate and lead to network imbalances. Setting the power control value in the RT 701 based on RSL will not guarantee a sufficient signal-to-noise (C/I) level at the HT 703 to demodulate the transmitted signal from the RT 701. The RSL or RSSI measurement will not permit dynamically responding to instantaneous increase of cochannel interference. Further, the static RSL value does not take into account the variation of receiver sensitivity; and the targeted RSL may be too large, causing excess cochannel interference to be generated. Unlike this single level approach, the present invention provides a multi-level power control loop.

The HT 703, according to one embodiment of the present invention, contains logic that provides three levels of power control feedback loops 705, 707, 709. The first level loop 705 uses the readily available, but less accurate signal parameter, Receive Signal Level (RSL); the loop 705 controls the uplink power level of the RT 701 to a specified signal level. The second level loop 707 controls the power control loop based on an appropriate signal-to-noise (C/I) level. The C/I measurements are more accurate, but require more examination of the uplink traffic to arrive at the measurement. Thus, the C/I measurement requires a longer time to acquire; this constraint has prevented the use of C/I measurements in the feedback loop in the conventional approaches. The present invention overcomes this constraint by utilizing the relatively quick first level loop 705 as a first order approximation, whereby the second level loop 707 then refines the power adjustment made by the first level loop 705.

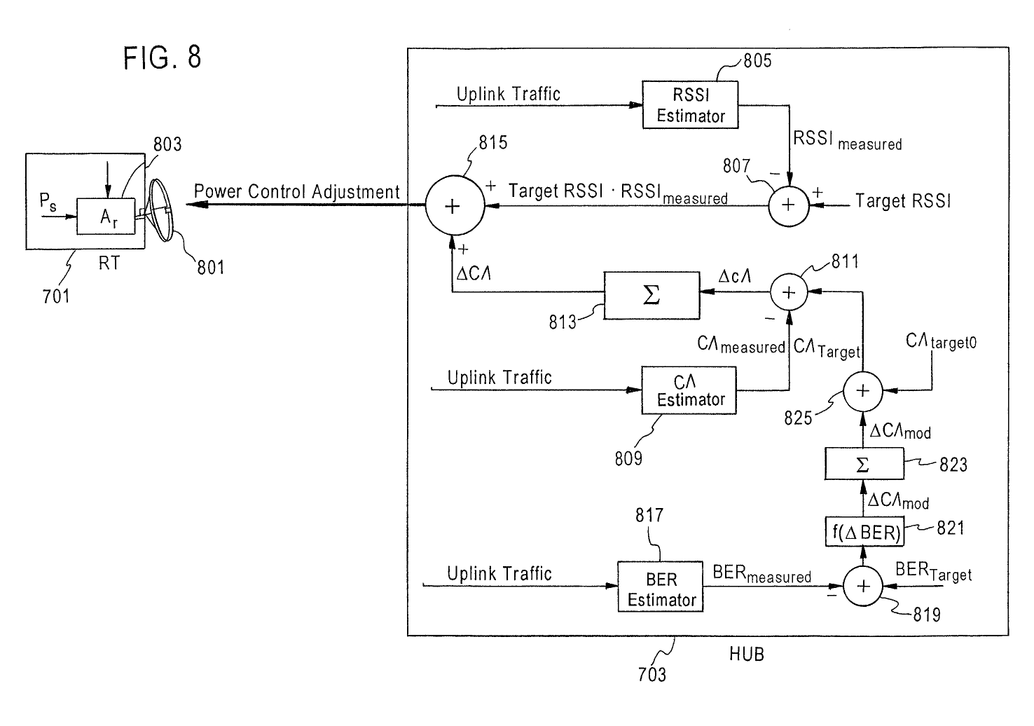

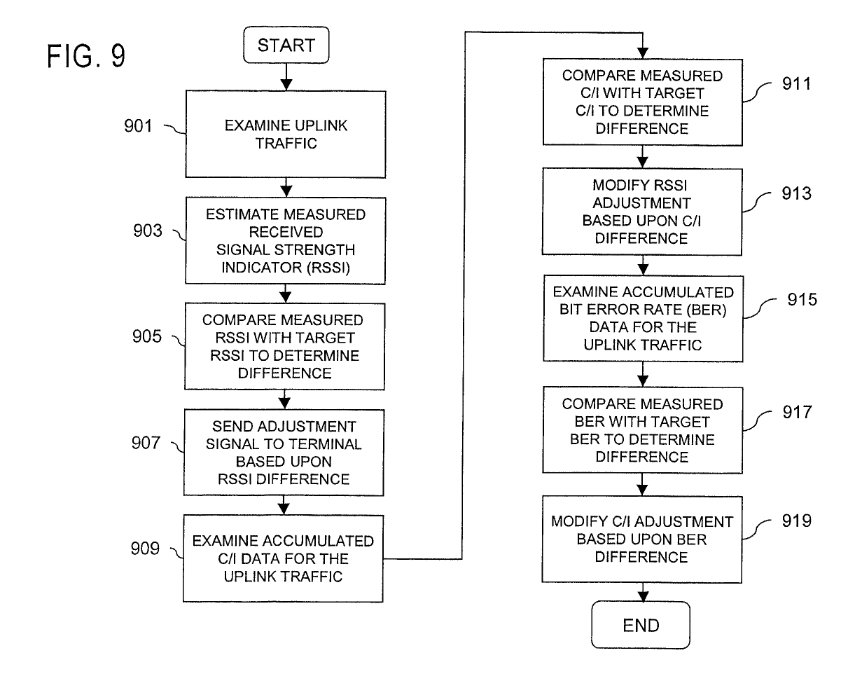

To obtain even greater accuracy in the power control, a third level loop 709 that is based upon a pre-FEC (forward error correction) Bit Error Rate (BER) information is used to control the RT output power. The collection of “raw” BER data requires examination of even more transmission signals than that required for the C/I measurement; however, BER provides the most accurate metric to control the uplink power, especially in point-to-multipoint systems. The interaction of the three loops 705, 707, 709 provide an accurate power control signal that is transmitted to the RT 701 to correct for improper transmission power (e.g., excessive power level). Essentially, the second level loop 707, which is based upon C/I, adjusts the first level loop 705 by examining the C/I values. Additionally, the third level loop 709 adjusts the second level loop 707 by analyzing BER values. The operation of this multi-level loop, which is made up of loops 705, 707, 709, is more fully described with respect to FIGS. 8 and 9, below.

Although, FIG. 7 shows the operation of three loops 705, 707, 709 to yield the power control signal, it is recognized that any subcombination of loops 705, 707, 709 may be employed depending on the environment of the RT 701 and the HT 703. For instance, the RSL power control loop 705 may be implemented with just the C/I power control loop 707. Alternatively, the multi-level power control loop may be implemented with only the C/I power control loop 707 and the BER power control loop 709.

By using multiple levels of feedback, which in this example is three, the HT 703 may optimally adjust to the interference environment and the varying parameters of the receiver circuitry within the HT 703. Importantly, under this arrangement, the signal parameter in the power control loop can be based upon the accurate BER metric. Under the conventional approach, the BER metric would take a prohibitively “long” time to estimate; however, the present invention eliminates this issue by using a multi-level feedback loop. FIG. 8 provides an exemplary implementation of the multi-level power control loop involving all three loops 705, 707, 709.

FIG. 8 shows a diagram of logic for providing a multi-level power control loop, according to an embodiment of the present invention. As an RT 701 comes on-line, the RT 701 transmits its signal via an antenna 801 toward the HT 703 with a certain power level, Pₛ, through an adjustable attenuator 803, Aᵣ. The attenuator 803 is controlled by downlink commands (i.e., power control signals) from the HT 703 to adjust the output transmit power level at the RT 701.

The HT 703 contains three individual concentric power control loops to regulate the power of the RT 701. The first power control loop utilizes a Received Signal Strength Indicator (RSSI) as the signal parameter for the feedback control; the RSSI value is a form of the RSL (discussed in FIG. 7). The second loop uses C/I as the signal parameter, while the third loop employs BER as the signal parameter.

FIG. 9 shows a flowchart of a process for providing a multi-level power control loop, according to an embodiment of the present invention. In step 901, the HT 703 examines the uplink traffic from the RT 701. The HT 703 includes a Received Signal Strength Indicator (RSSI) estimator 805 to measure the uplink traffic from the RT 701, per step 903. RSSI can be measured for each data burst received from the RT 701. The RSSI estimator 805 outputs a measured RSSI value, RSSI_{measured}, which is compared, as in step 905, with a predetermined target RSSI value, RSSI_{target}, at a comparator 807. The output of the comparator 807 represents the difference between RSSI_{measured} and RSSI_{target}. The power control adjustment based on this difference is broadcast downlink to the RT 701 (per step 907); the power control adjustment is further refined by the second level control loop, which is based, in this example, on C/I.

In step 909, the accumulated C/I data is examined. In particular, concurrent with the analysis of the RSSI values, the HT 703 has a C/I estimator 809 to measure the C/I associated with the uplink traffic from the RT 701. To obtain an accurate C/I measurement, several data bursts are collected to provide the measured C/I. The measured C/I from the C/I estimator 809 is compared to the target C/I through a comparator 811 (per step 911). The output of the comparator 811 is the difference (Δc/i) between the measured C/I and the target C/I. The Δc/i value is input into a summation circuit 813, which accumulates the differences to comparator 815 as ΔC/I; the comparator 815, thus, modifies the adjustment based upon the RSSI difference with the ΔC/I. The ΔC/I is added to the RSSI target value and is used to form the new power control adjustment to the RSSI (per step 913) and is broadcast to the RT.

The target C/I is based on the desired BER. As with the C/I measurements, an accurate measure of BER is determined through examination of numerous data bursts; thus, BER data is accumulated and examined (step 915). In an exemplary embodiment, pre-FEC (forward error correction) (i.e., raw BER) is measured; post FEC BER value can be as small as 10⁻¹³, which computationally may require several days of data collection. This would make the BER metric impractical. By contrast, target pre-FEC BERs values range from 10⁻⁴ to 10⁻⁶, requiring a shorter collection period. The raw BER can therefore be used, because there is a one to one correspondence between the raw BER and the post-FEC BER. It is noted that the BER metric cannot be used under the conventional power control loop approach, because if the power control were only based on BER, the reaction times would be several minutes. This poor reaction time would not be effective to properly correct power. However, the present invention permits the use of the BER metric.

Using the BER metric corrects any biases in the hub receiver to relate the C/I to the BER. This relationship determines the setting of the C/I of the system and can vary from receiver to receiver and over temperature. When the bit errors are collected and the pre-FEC BER is estimated by a BER estimator 817, the measured pre-FEC BER is compared to the target pre-FEC BER by comparator 819 (step 917). The output of the comparator 819 is input into a converter 821, which converts the BER differences into C/I values (Δc/i). These Δc/i values are then fed into a summation circuit 823, which accumulates the Δc/i values, to output an adjustment value, ΔC/I, to a comparator 825. The output of the comparator 825 is an adjusted target C/I, per step 919. Thus, the target C/I of the second level power loop is modified based on the BER difference. Effectively, this modification results in adjustment to the target RSSI; the RSSI deviation of the measured RSSI to a new target RSSI is broadcast to the RT 701.

Therefore, the RT uplink transmit power is adjusted such that it matches the target RSSI adjusted for the adaptive target C/I value, which in turn was adjusted by the measured BER value. Accordingly, this process associates a target RSSI value with a BER value. Because for any cochannel or adjacent channel interference, the BER would rise; the increase in BER would generate adjustments to the C/I target value and the RSSI target value. These adjustments would work to increase the output power of the RT to counteract the reduced BER. The above arrangement therefore provides a more accurate feedback mechanism.

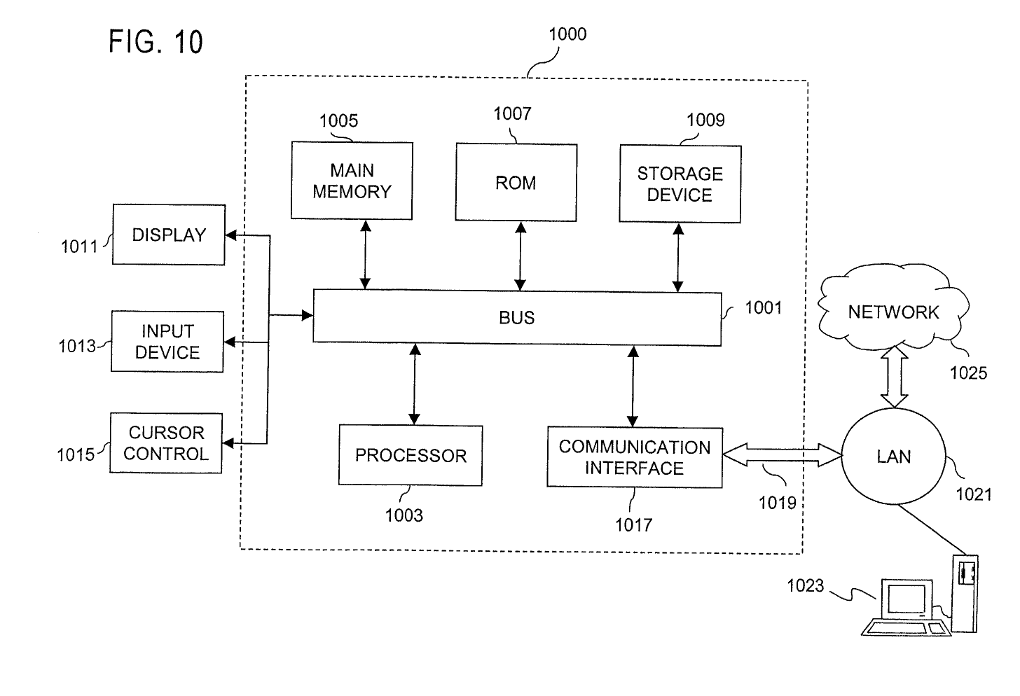

FIG. 10 illustrates a computer system 1000 upon which an embodiment according to the present invention can be implemented. The computer system 1000 includes a bus 1001 or other communication mechanism for communicating information, and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions to be executed by the processor 1003. The computer system 1000 further includes a read only memory (ROM) 1007 or other static storage device coupled to the bus 1001 for storing static information and instructions for the processor 1003. A storage device 1009, such as a magnetic disk or optical disk, is additionally coupled to the bus 1001 for storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is cursor control 1015, such as a mouse, a trackball, or cursor direction keys for communicating direction information and command selections to the processor 1003 and for controlling cursor movement on the display 1011.

According to one embodiment of the invention, the multi-level power control loop is provided by the computer system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the present invention. Thus, embodiments of the present invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, or a telephone modem to provide a data communication connection to a corresponding type of telephone line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by service provider. The local network 1021 and network 1025 both use electrical, electromagnetic, or optical signals to convey information and instructions. The signals through the various networks and the signals on network link 1019 and through communication interface 1017, which communicate digital data with computer system 1000, are exemplary forms of carrier waves bearing the information and instructions.

The computer system 1000 can send messages and receive data, including program code, through the network(s), network link 1019, and communication interface 1017. In the Internet example, a server (not shown) might transmit requested code belonging an application program for implementing an embodiment of the present invention through the network 1025, local network 1021 and communication interface 1017. The processor 1004 may execute the transmitted code while being received and/or store the code in storage device 109, or other non-volatile storage for later execution. In this manner, computer system 1000 may obtain application code in the form of a carrier wave.

The term “computer-readable medium” as used herein refers to any medium that participates in providing instructions to the processor 1004 for execution. Such a medium may take many forms, including but not limited to non-volatile media, volatile media, and transmission media. Non-volatile media include, for example, optical or magnetic disks, such as storage device 1009. Volatile media include dynamic memory, such as main memory 1005. Transmission media include coaxial cables, copper wire and fiber optics, including the wires that comprise bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, the present invention provides a multi-level power control loop to control power of a radio terminal. In an exemplary embodiment, three levels of power control loops form the multi-level power control loop. The third level loop modifies the adjustments of the second level loop, which in turn, corrects the power adjustments made by the first level loop. The first level control loop uses a Receive Signal Level (RSL) parameter to power control the radio terminal to a specified signal level. The second level loop controls the power level based on a Signal-to-Noise ratio level (C/I), while the third level loop utilizes a pre-FEC (forward error correction) Bit Error Rate (BER) to control the output power. The present invention advantageously minimizes interference and enhances efficient use of system resources.

While the present invention has been described in connection with a number of embodiments and implementations, the present invention is not so limited but covers various obvious modifications and equivalent arrangements, which fall within the purview of the appended claims.

What is claimed is:

1. A method for providing power control of a radio terminal, the method comprising:
receiving a signal from the radio terminal;
performing a first control loop according to a first set of signal parameters to adjust power level of the radio terminal based upon the received signal; and
performing a second control loop according to a second set of signal parameters to refine the power adjustment of the first control loop.

2. A method according to claim 1, wherein the first set of signal parameters includes a first measured signal parameter and a first target signal parameter, the step of performing the first control loop comprising:
comparing the first measured signal parameter with the first target signal parameter; and
selectively transmitting a control signal to the radio terminal to adjust power level of the radio terminal based upon the comparing step.

3. A method according to claim 1, wherein the first set of signal parameters is based upon a received signal level, and the second set of signal parameters is based upon a signal-to-noise ratio level.

4. A method according to claim 1, wherein the first set of signal parameters is based upon a signal-to-noise ratio level, and the second set of signal parameters is based upon a bit error rate (BER).

5. A method according to claim 1, further comprising:
performing a third control loop according to a third set of signal parameters to refine the adjustment of the second control loop.

6. A method according to claim 5, wherein the first set of signal parameters is based upon a received signal level, the second set of signal parameters is based upon a signal-to-noise ratio level, and the third set of signal parameters is based upon a bit error rate (BER).

7. A method according to claim 1, wherein the radio terminal is configured to operate in at least one of a point-to-multipoint radio communications system and a point-to-point radio communications system.

8. A terminal apparatus for providing power control of a radio terminal, comprising:
an antenna configured to receive a signal from the radio terminal; and
logic configured to perform a first control loop according to a first set of signal parameters to adjust power level of the radio terminal based upon the received signal, the logic being further configured to perform a second control loop according to a second set of signal parameters to refine the power adjustment of the first control loop.

9. An apparatus according to claim 8, wherein the first set of signal parameters includes a first measured signal parameter and a first target signal parameter, the logic including,
an estimator configured to output the first measured signal parameter in response to the received signal, and
a comparator configured to compare the first measured signal parameter with the first target signal parameter, the logic selectively initiating transmission of a control signal to the radio terminal to adjust power level of the radio terminal based upon the comparison.

10. An apparatus according to claim 8, wherein the first set of signal parameters is based upon a received signal level, and the second set of signal parameters is based upon a signal-to-noise ratio level.

11. An apparatus according to claim 8, wherein the first set of signal parameters is based upon a signal-to-noise ratio level, and the second set of signal parameters is based upon a bit error rate (BER).

12. An apparatus according to claim 8, wherein the logic is further configured to perform a third control loop according to a third set of signal parameters to refine the adjustment of the second control loop.

13. An apparatus according to claim 12, wherein the first set of signal parameters is based upon a received signal level, the second set of signal parameters is based upon a signal-to-noise ratio level, and the third set of signal parameters is based upon a bit error rate (BER).

14. An apparatus according to claim 8, wherein the antenna is configured to provide point-to-multipoint or point-to-point transmission.

15. A terminal apparatus for providing power control of a radio terminal, comprising:
a communications interface configured to receive data from a host;
a transmitter configured to transmit a signal representing the data from the host to a hub terminal; and
an attenuator coupled to the transmitter and configured to control power level of the signal,
wherein the hub terminal includes logic configured to perform a first control loop according to a first set of signal parameters to control the attenuator to adjust power level of the transmitter based upon the received signal, the logic being further configured to perform a second control loop according to a second set of signal parameters to refine the power adjustment of the first control loop.

16. An apparatus according to claim 15, wherein the first set of signal parameters includes a first measured signal parameter and a first target signal parameter, the logic including,
an estimator configured to output the first measured signal parameter in response to the signal, and
a comparator configured to compare the first measured signal parameter with the first target signal parameter, the hub terminal selectively transmitting a control signal to adjust power level of the transmitter based upon the comparison.

17. An apparatus according to claim 15, wherein the first set of signal parameters is based upon a received signal level, and the second set of signal parameters is based upon a signal-to-noise ratio level.

18. An apparatus according to claim 15, wherein the first set of signal parameters is based upon a signal-to-noise ratio level, and the second set of signal parameters is based upon a bit error rate (BER).

19. An apparatus according to claim 15, wherein the logic is further configured to perform a third control loop according to a third set of signal parameters to refine the adjustment of the second control loop.

20. An apparatus according to claim 19, wherein the first set of signal parameters is based upon a received signal level, the second set of signal parameters is based upon a signal-to-noise ratio level, and the third set of signal parameters is based upon a bit error rate (BER).

21. An apparatus according to claim 15, wherein the communications interface couples to a point-to-multipoint or point-to-point radio communications system.

22. A communications system for providing multi-level transmission power control, comprising:
a first terminal configured to receive data from a host and to transmit a signal representing the data from the host; and
a second terminal configured to receive the signal, the second terminal including logic configured to perform a first control loop according to a first set of signal parameters to adjust power level of the first terminal based upon the received signal, the logic being further configured to perform a second control loop according to a second set of signal parameters to refine the power adjustment of the first control loop.

23. A system according to claim 22, wherein the first set of signal parameters includes a first measured signal parameter and a first target signal parameter, the logic including,
an estimator configured to output the first measured signal parameter in response to the signal, and
a comparator configured to compare the first measured signal parameter with the first target signal parameter, the logic selectively initiating transmission of a control signal to the first terminal to adjust power level based upon the comparison.

24. A system according to claim 22, wherein the first set of signal parameters is based upon a received signal level, and the second set of signal parameters is based upon a signal-to-noise ratio level.

25. A system according to claim 22, wherein the first set of signal parameters is based upon a signal-to-noise ratio level, and the second set of signal parameters is based upon a bit error rate (BER).

26. A system according to claim 22, wherein the logic is further configured to perform a third control loop according to a third set of signal parameters to refine the adjustment of the second control loop.

27. A system according to claim 26, wherein the first set of signal parameters is based upon a received signal level, the second set of signal parameters is based upon a signal-to-noise ratio level, and the third set of signal parameters is based upon a bit error rate (BER).

28. A system according to claim 22, wherein the first terminal communicates with the second terminal over at least one of a point-to-multipoint network and a point-to-point network.

29. A terminal apparatus for providing power control of a radio terminal, comprising:
means for receiving a signal from the radio terminal;
means for performing a first control loop according to a first set of signal parameters to adjust power level of the radio terminal based upon the received signal; and
means for performing a second control loop according to a second set of signal parameters to refine the power adjustment of the first control loop.

30. An apparatus according to claim 29, wherein the first set of signal parameters includes a first measured signal parameter and a first target signal parameter, the means for performing the first control loop comprising:
means for comparing the first measured signal parameter with the first target signal parameter; and
means for selectively transmitting a control signal to the radio terminal to adjust power level of the radio terminal based upon the comparing step.

31. An apparatus according to claim 29, wherein the first set of signal parameters is based upon a received signal level, and the second set of signal parameters is based upon a signal-to-noise ratio level.

32. An apparatus according to claim 29, wherein the first set of signal parameters is based upon a signal-to-noise ratio level, and the second set of signal parameters is based upon a bit error rate (BER).

33. An apparatus according to claim 29, further comprising:
means for performing a third control loop according to a third set of signal parameters to refine the adjustment of the second control loop.

34. An apparatus according to claim 33, wherein the first set of signal parameters is based upon a received signal level, the second set of signal parameters is based upon a signal-to-noise ratio level, and the third set of signal parameters is based upon a bit error rate (BER).

35. An apparatus according to claim 29, wherein the radio terminal is configured to operate in at least one of a point-to-multipoint radio communications system and a point-to-point radio communications system.

36. A computer-readable medium carrying one or more sequences of one or more instructions for providing power control of a radio terminal, the one or more sequences of one or more instructions including instructions which, when executed by one or more processors, cause the one or more processors to perform the steps of:
performing a first control loop according to a first set of signal parameters to adjust power level of the radio terminal based upon a received signal from the radio terminal; and
performing a second control loop according to a second set of signal parameters to refine the power adjustment of the first control loop.

37. A computer-readable medium according to claim 36, wherein the first set of signal parameters includes a first measured signal parameter and a first target signal parameter, the step of performing the first control loop comprising:
comparing the first measured signal parameter with the first target signal parameter; and
selectively transmitting a control signal to the radio terminal to adjust power level of the radio terminal based upon the comparing step.

38. A computer-readable medium according to claim 36, wherein the first set of signal parameters is based upon a received signal level, and the second set of signal parameters is based upon a signal-to-noise ratio level.

39. A computer-readable medium according to claim 36, wherein the first set of signal parameters is based upon a signal-to-noise ratio level, and the second set of signal parameters is based upon a bit error rate (BER).

40. A computer-readable medium according to claim 36, wherein the one or more processors further perform the step of:
performing a third control loop according to a third set of signal parameters to refine the adjustment of the second control loop.

41. A computer-readable medium according to claim 40, wherein the first set of signal parameters is based upon a received signal level, the second set of signal parameters is based upon a signal-to-noise ratio level, and the third set of signal parameters is based upon a bit error rate (BER).

42. A computer-readable medium according to claim 36, wherein the radio terminal is configured to operate in at least one of a point-to-multipoint radio communications system and a point-to-point radio communications system.
